(19) United States
(12) Patent Application Publication
(10) Pub. No.: US 2016/0305610 A1
(43) Pub. Date: Oct. 20, 2016

(54) LOW HEAT LOSS CRYOGENIC LIQUID CONTAINER

(71) Applicant: KOREA INSTITUTE OF SCIENCE AND TECHNOLOGY, Seoul (KR)

(72) Inventors: Sarng Woo KARNG, Seoul (KR); Seo Young KIM, Seoul (KR); Jong Hoon BAIK, Cocoa, FL (US); In Hwan OH, Seoul (KR)

(21) Appl. No.: 15/096,461

(22) Filed: Apr. 12, 2016

(30) Foreign Application Priority Data
Apr. 15, 2015 (KR) 10-2015-0053295

(51) Int. Cl. F17C 13/00; F17C 3/08

(52) U.S. Cl. CPC F17C 13/001; F17C 3/08; F17C 2203/0304; F17C 2203/0629; F17C 2203/0391; F17C 2205/0149; F17C 2205/0352; F17C 2221/033; F17C 2260/031; F17C 2270/01

(57) ABSTRACT

Provided is a low heat loss cryogenic liquid container, which includes: an outer container, to an upper end of which an upper end cover is coupled and an interior of which is maintained in a vacuum; an inner container that is disposed inside the outer container apart from an inner wall of the outer container and contains a cryogenic liquid; a liquid inflow/outflow pipe that connects an exterior of the outer container and an interior of the inner container and serves as a passage for charging and/or discharging the cryogenic liquid; and a support including a strut member that is disposed between an inner lower surface of the outer container and an outer lower surface of the inner container and is formed of a low heat conductivity material to interrupt heat conduction, and springs disposed at least one position between an upper end of the strut member and the outer lower surface of the inner container, between a lower end of the strut member and the inner lower surface of the outer container, and between both of the ends of the strut member.

### CROSS-REFERENCE TO RELATED APPLICATION

This application claims the benefit of Korean Patent Application No. 2015-0053295, filed on Apr. 15, 2015, the disclosure of which is hereby incorporated herein by reference in its entirety.

### BACKGROUND OF THE INVENTION

1. Field of the Invention

The present invention relates generally to a low heat loss cryogenic liquid container, and more particularly, to a low heat loss cryogenic liquid container used in a storage system for storing a cryogenic liquid such as liquefied natural gas (LNG), liquefied petroleum gas (LPG), liquid oxygen, liquid nitrogen, liquid helium, or liquid hydrogen and a liquefaction system for liquefying the gases.

2. Description of the Related Art

Recently, as the measure for solving problems of air pollution and global warming caused by excessive use of fossil fuel, researches for a system using energy sources other than hydrocarbon fuel have been actively carried out in domestic and foreign countries. Among several methods, the most representative method is a technology for a use of hydrogen as energy source.

In order to efficiently utilize hydrogen energy, a volume of the hydrogen should be reduced to make high density hydrogen. Using high density hydrogen results in superior storage, transport, and ease of use compared to lower density hydrogen. Of the various ways of storing hydrogen, liquefying and storing hydrogen in a liquid phase maintains the largest energy storage. Thus, to extend the utilization of hydrogen energy, cryogenic equipment is needed with the capability of effectively storing hydrogen in a liquid to be convenient to transport and store.

In order to store a cryogenic liquid, a heat-insulation technique for a storage container which can minimize a loss of evaporation caused by a heat inflow from the outside is very critical. For the above, various methods such as vacuum insulation, multilayer insulation (MLI), and the like have been complexly utilized in the cryogenic equipment. It has been well known that, by means of the above method, it is possible to considerably reduce conductive heat transfer, convective heat transfer, and radiant heat transfer caused by air.

At the present, the storage container to which the above technologies are applied has been developed and utilized for storing and transferring LNG, liquid nitrogen, etc. In order to store and transfer liquid hydrogen at a temperature of −253° C., however, the cryogenic equipment having improved heat insulation performance and cryogenic stability should be indispensably developed.

Existing cryogenic containers each include an inner container that is filled with a cryogenic liquid, an outer container that houses the inner container and forms a vacuum between the inner container and the outer container, a support that fixes an upper end of the inner container to an upper end of the outer container so as to suspend the inner container from the outer container, a liquid inflow/outflow pipe that charges and discharges the cryogenic liquid, and a heat insulation layer that encloses the inner container to insulate the inner container against heat.

In such cryogenic containers, the support is used to suspensibly fix the inner container to the outer container, and opposite ends thereof are in direct contact with the inner container of a cryogenic temperature and the outer container of room temperature respectively. Thus, there is a problem in that the support serves as a conduction heat transfer path from the outside to the cryogenic liquid. Since the difference in temperature between both ends is large (approximately 280K), conductive heat transfer through the support may be extremely large. Therefore, when heat intrusion resulting from the conduction heat transfer is not effectively reduced, a rate of loss of evaporation of the cryogenic liquid sharply increases due to a large quantity of heat inflow, which leads to a problem that a liquid desired to be stored cannot be stored for a long time.

Further, such a cryogenic container has a disadvantage in that the inner container is supported inside the outer container in a suspended state only, and thus structural stability is relatively low.

### SUMMARY OF THE INVENTION

The present invention has been made to solve the above problems, and an object of the present invention is to provide a low heat loss cryogenic liquid container in which, in a dual container structure having an inner container and an outer container housing the inner container, a support capable of supporting the inner container is formed between an inner lower surface of the outer container and an outer lower surface of the inner container, and thereby conduction heat intrusion caused by the support can be minimized with the improvement in structural stability.

Further, another object of the present invention is to provide a low heat loss cryogenic liquid container in which, in a dual container structure having an inner container and an outer container housing the inner container, a support capable of absorbing displacement and deformation of the inner container depending on heat contraction and expansion is provided.

To achieve the objects, according to an aspect of the present invention, there is provided a low heat loss cryogenic liquid container, which includes: an outer container, to an upper end of which an upper end cover is coupled and an interior of which is maintained in a vacuum; an inner container that is disposed inside the outer container apart from an inner wall of the outer container and contains a cryogenic liquid; a liquid inflow/outflow pipe that connects an exterior of the outer container and an interior of the inner container and serves as a passage for charging and/or discharging the cryogenic liquid; and a support that is disposed between an inner lower surface of the outer container and an outer lower surface of the inner container and includes a strut member formed of a low heat conductivity material in order to interrupt heat conduction and at least one spring coupled to the strut member such that the inner container is displaceable up and down relative to the outer container.

Herein, the outer lower surface of the inner container and the inner lower surface of the outer container may be respectively formed with an upper bearing and a lower bearing, which include holding recesses in which upper and lower ends of the strut member are respectively held and supported, at positions opposite to each other.

Further, the holding recess of the upper bearing which is formed in the lower surface of the inner container is recessed upward from the lower surface of the inner container.

Further, the upper and lower ends of the strut member may include contact seats, each of which has a cross section whose width or diameter is larger than an outer diameter of a tube positioned between the upper and lower ends of the strut member and has a shape tapered toward an end thereof.

Also, the spring may be disposed inside the holding recess at at least one position of between the upper end of the strut member and the outer lower surface of the inner container and between the lower end of the strut member and the inner lower surface of the outer container.

Herein, the strut member may include a hollow tube in a vacuum at the core thereof.

In addition, the strut member may include a hollow tube in a vacuum and plug members coupled to upper and lower ends of the hollow tube. The plug members may include fitting portions fitted into opposite ends of the hollow tube and the contact seats integrally formed with the fitting portions, wherein at least one of the fitting portions of the plug members coupled to upper and lower ends of the hollow tube is coupled to be movable up and down along the hollow tube. The spring may be disposed inside or around the hollow tube between the plug members.

Further, heat isolation blocks formed of a low heat conductivity material are installed in the holding recesses between the upper or lower end of the strut member and the outer lower surface of the inner container or the inner lower surface of the outer container.

Further, when the heat isolation block is disposed in the holding recess in the vicinity of the outer lower surface of the inner container or the inner lower surface of the outer container, an epoxy pad supporting the heat isolation block is provided at an inner edge of the holding recess.

Further, the low heat conductivity material includes a glass reinforced epoxy laminate (GREL).

According to the present invention, a low heat loss cryogenic liquid container in which a support capable of supporting an inner container is formed between an inner lower surface of an outer container and an outer lower surface of the inner container and which is able to minimize conduction heat intrusion caused by the support with the improvement in structural stability can be provided. In the heat conduction aspect, heat is conducted from the outer container, an exterior of which is at room temperature, to the inner container, an interior of which is a cryogenic temperature, via a strut member and heat isolation blocks. Since the strut member and the heat isolation blocks are formed of a low heat conductivity material, and preferably a glass reinforced epoxy laminate (GREL), the heat conduction can be minimized.

According to the present invention, since the support supporting the inner container includes at least one spring, displacement and deformation of the inner container depending on heat contraction and expansion can be absorbed by the spring. Therefore, thermal stress of the inner container can be relieved and reduced.

### BRIEF DESCRIPTION OF THE DRAWINGS

The foregoing and other objects, features and advantages of the invention will become more readily apparent upon consideration of the following detailed description of the invention taken in conjunction with the accompanying drawings which illustrate preferred and exemplary embodiments, but which are not necessarily drawn to scale, wherein:

FIG. 1 is a schematic sectional view illustrating a low heat loss cryogenic liquid container according to the present invention; and

FIG. 2 is a partially enlarged view illustrating the low heat loss cryogenic liquid container according to the present invention.

### DETAILED DESCRIPTION OF THE INVENTION

Hereinafter, a low heat loss cryogenic liquid container according to the present invention will be described in detail with reference to the accompanying drawings.

The low heat loss cryogenic liquid container illustrated in the drawings in accordance with the present invention will be described as being applied to a cryogenic liquid storage system, but it may be applied to a liquefaction system.

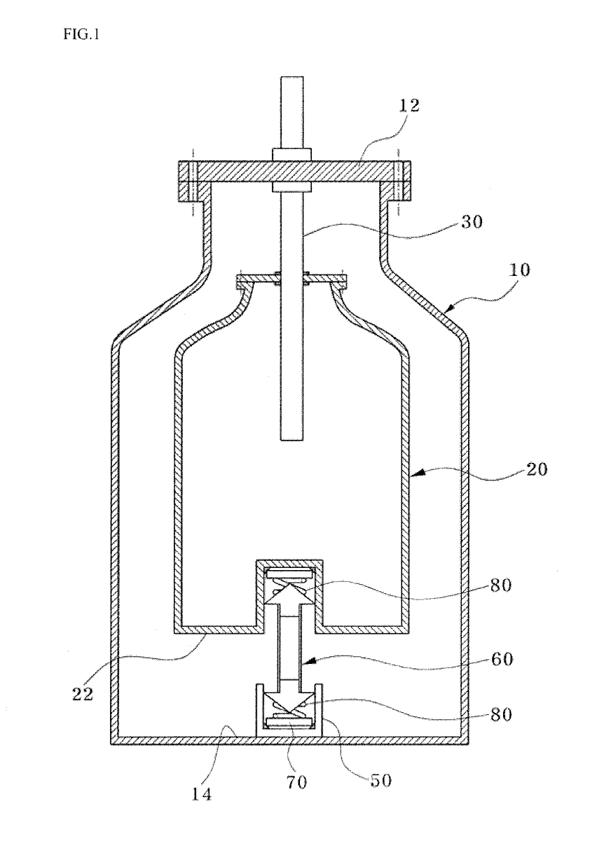

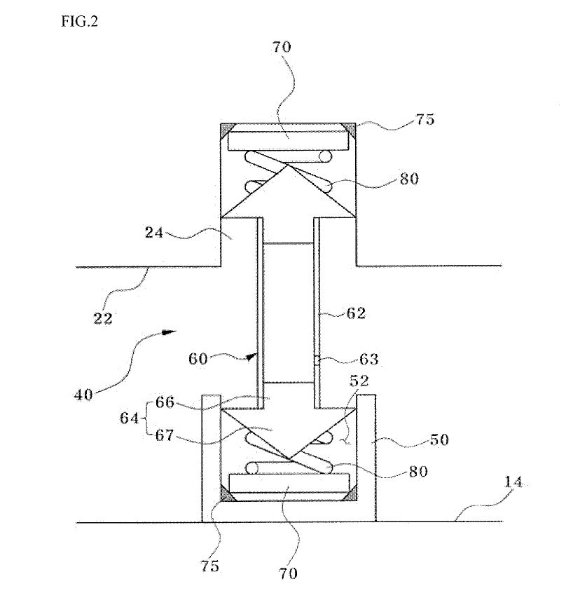

FIG. 1 is a schematic sectional view illustrating a low heat loss cryogenic liquid container according to the present invention, and FIG. 2 is a partially enlarged view illustrating the low heat loss cryogenic liquid container according to the present invention.

Referring to FIGS. 1 and 2, the low heat loss cryogenic liquid container according to the present invention includes an outer container 10, an inner container 20, a liquid inflow/outflow pipe 30, and a support 40.

The outer container 10 is a tub-like container, to an upper end of which an upper end cover 12 is coupled to seal an interior thereof. In a state in which the upper end cover 12 is disassembled, the other components including the inner container 20 are installed in the outer container 10 through the open upper end. In a state in which the outer container 10 is sealed with the upper end cover 12, the interior of the outer container 10 is maintained in a vacuum. The liquid inflow/outflow pipe 30 passes through the upper end cover 12, extends to the interior of the outer container 10, and is connected to the inner container 20.

The inner container 20 is a tub in which a cryogenic liquid such as liquefied natural gas (LNG), liquefied petroleum gas (LPG), liquid oxygen, liquid nitrogen, liquid helium, liquid hydrogen, or the like is stored, and is disposed inside the outer container 10 apart from an inner wall of the outer container 10. That is, the inner container 20 is spaced apart from an upper surface, an inner circumferential surface, and a lower surface of the outer container 10.

An upper bearing 24 for the support 40 is formed in the center of an outer lower surface 22 of the inner container 20. In the embodiment of the present invention, the upper bearing 24 is preferably made up of a holding recess recessed in the center of the outer lower surface 22 of the inner container 20 in an upward direction. However, the upper bearing 24 may be formed to protrude downward from the outer lower surface 22 of the inner container 20. The holding recess of the upper bearing 24 has a width corresponding to a maximum width of one of plug members 64 of a strut member 60 included in the support 40. The plug member 64 is held and supported in the holding recess of the upper bearing 24.

A vacuum formed between the inner circumferential surface of the outer container 10 and an outer circumferential surface of the inner container 20 forms a vacuum heat insulation layer. The vacuum heat insulation layer minimizes convection heat transfer between the outer container 10, an exterior of which is at room temperature, and the inner container 20, an interior of which is at a cryogenic temperature.

Various heat insulation structures including a multilayer heat insulator (not shown) enclosing the inner container 20 may be provided in a space between the outer container 10 and the inner container 20 in addition to the vacuum heat insulation layer.

The liquid inflow/outflow pipe 30 that connects the exterior of the outer container 10 and the interior of the inner container 20 and serves as a passage for charging and/or discharging the cryogenic liquid. The liquid inflow/outflow pipe 30 is connected to the inner container 20 by extending from the exterior of the outer container 10 through the upper end cover 12 to the interior of the inner container 20, and a lower end thereof extends to the interior of the inner container 20.

A lower bearing 50 for the support 40 is formed on an inner lower surface 14 of the outer container 10. The lower bearing 50 is provided with a cylindrical holding recess 52 at a position corresponding to the holding recess of the upper bearing 24. The holding recess 52 has a width corresponding to the maximum width of the other plug member 64 of the strut member 60 included in the support 40. The other plug member 64 is held and supported in the holding recess 52 of the lower bearing 50.

According to the present invention, the support 40 is installed between the inner lower surface 14 of the outer container 10 and the outer lower surface 22 of the inner container 20, and the inner container 20 is elastically supported such that thermal deformation is absorbed while being supported upward with respect to the outer container 10.

According to the present invention, the support 40 includes the strut member 60 and springs 80.

The strut member 60 is supported between the outer lower surface 22 of the inner container 20 and the inner lower surface 14 of the outer container 10 such that the inner container 20 is supported with respect to the outer container 10. A lower end of the strut member 60 is held and supported in the holding recess 52 of the lower bearing 50, and an upper end of the strut member 60 is held and supported in the holding recess of the upper bearing 24.

According to the embodiment illustrated in FIGS. 1 and 2, the strut member 60 includes a hollow tube 62, opposite ends of which are open, and the plug members 64 that are fixed to the opposite ends of the hollow tube 62 and are each provided with a contact seat 67. One of the springs 80 is supported on the contact seat 67 in the upper holding recess and the outer lower surface of the inner container 20, and the other is supported on the contact seat 67 in the lower holding recess and the inner lower surface of the outer container 10.

An interior of the hollow tube 62 constituting a core between the opposite ends of the strut member 60 is maintained in a vacuum. To this end, an air vent hole 63 is formed in the hollow tube 62 such that the vacuum is formed together with the interior of the hollow tube 62 when air is discharged from the outer container 10 so as to form the vacuum. Alternatively, independently of forming the vacuum in the outer container 10, the interior of the hollow tube 62 may be maintained under the vacuum from the beginning when the strut member 60 is manufactured. The vacuum of the interior of the hollow tube 62 forms a vacuum heat insulation layer that functions to interrupt convection heat transfer of the interior of the hollow tube 62 and heat conduction caused by air.

The plug members 64 are fitted into the open opposite ends of the hollow tube 62. Each of the plug members 64 includes a fitting portion 66 fitted into each of the open opposite ends of the hollow tube 62 and the contact seat 67 integrally formed with the fitting portion 66. The contact seat 67 has a cross section whose width or diameter is larger than an outer diameter of the hollow tube 62, and is formed in a shape tapered toward an end thereof, for instance, in a truncated polygonal pyramid shape or a truncated cone shape. A width or diameter cut across outermost portions of the contact seat 67 corresponds to an inner diameter of the holding recess of the upper or lower bearing 24 or 50. The contact seats 67 are supported in contact with inner circumferential surfaces of the holding recesses of the upper and lower bearings 24 and 50.

When each of the contact seats 67 has the truncated cone shape, the outermost portion thereof forms a circle, and thus is supported while being in line contact with the inner circumferential surface of the holding recess of each of the upper and lower bearings 24 and 50. When each of the contact seats 67 has the truncated polygonal pyramid shape, the outermost portions thereof correspond to vertexes, and thus are supported while being in point contact with the inner circumferential surface of the holding recess of each of the upper and lower bearings 24 and 50. Thereby, the heat conduction can be minimized.

Further, since the contact seats 67 are formed in the shape tapered toward the ends thereof, the ends of the contact seats 67 of the plug members 64 are in point contact with abutting targets in the holding recesses of the upper and lower bearings 24 and 50. Therefore, when heat isolation blocks 70 are installed in the holding recesses of the upper and lower bearings 24 and 50, the contact seats 67 can minimize the heat conduction while being in point contact with the heat isolation blocks 70.

The strut member 60 may be formed of a low heat conductivity material in order to interrupt the heat conduction. The low heat conductivity material may preferably include a glass reinforced epoxy laminate (GREL). The GREL is suitable to provide functions for physical support and heat conduction interruption together. Types of the GREL include G-10, G-11, G-10 CR, and so on.

Further, the strut member 60 is configured in such a manner that the hollow tube 62 is coupled with the plug members 64. Thus, this configuration can reduce a heat conduction area compared to when the strut member 60 is formed in one body. Accordingly, a quantity of the heat conduction between the plug members 64 located at the opposite ends of the strut member 60 can be further reduced.

Meanwhile, one of the springs 80 of the support 40 may be provided for the hollow tube 62 of the strut member 60. The strut member 60 is formed by the coupling of the hollow tube 62 and the plug members 64. The spring 80 may be disposed between the plug members 64 in such a manner that the spring 80 is installed inside the hollow tube 62 and elastically supports the fitting portions 66 of the plug members 64 or that the spring 80 is installed around the hollow tube 62 and elastically supports the contact seats 67 of the plug members 64. Thermal deformation and displacement of the inner container 20 are absorbed while the plug members 64 slide relative to the hollow tube 62.

The heat isolation blocks 70 are formed in a disc shape, and are respectively disposed in the holding recesses of the upper and lower bearings 24 and 50. The heat isolation blocks 70 function to further interrupt the heat conduction between the strut member 60 and the outer lower surface 22 of the inner container 20 and between the strut member 60 and the inner lower surface 14 of the outer container 10 and to increase efficiency of interrupting the heat conduction. The heat isolation blocks 70 are formed of a low heat conductivity material, and preferably GREL.

Epoxy pads 75 are provided at an inner edge of the holding recess 52 of the lower bearing 50 and an inner edge of the holding recess of the upper bearing 24. The epoxy pads 75 function to support edges of the heat isolation blocks 70 to prevent a lower surface of the lower heat isolation block 70 and an upper surface of the upper heat isolation block 70 from coming into plane contact with a wall surface of the holding recess 52 of the lower bearing 50 and a wall surface of the holding recess of the upper bearing 24 and to minimize a contact area. Since the heat conduction is influenced by the contact area, the epoxy pads 75 are additionally provided, and thereby the heat conduction caused by the heat isolation blocks 70 can be further minimized.

When the springs 80 are installed between the opposite ends of the strut member 60 and the heat isolation blocks 70, the contact seat 67 of the plug member 64 at the lower end of the strut member 60 is supported on the lower heat isolation block 70 via the spring 80, and the contact seat 67 of the plug member 64 at the upper end of the strut member 60 is supported on the upper heat isolation block 70 via the spring 80.

According to another embodiment of the present invention, the springs 80 may be interposed between the heat isolation block 70 and the outer lower surface 22 of the inner container 20 and between the heat isolation block 70 and the inner lower surface 14 of the outer container 10 in the holding recesses of the upper bearing 24 and the lower bearing 50. In this case, the epoxy pads 75 are omitted. The heat isolation blocks 70 function to prevent the lower surfaces of the inner container 20 and the outer container 10 from conducting heat to the strut member 60 via the springs 80.

In the case of a conventional cryogenic liquid container, the displacement and deformation of the inner container occur when heat contraction and expansion occurs due to a change in temperature depending on inflow and outflow of the cryogenic liquid, and thus the inner container 20 is exposed to thermal stress. In contrast, according to the present invention, the displacement and deformation of the inner container 20 depending on the heat contraction and expansion can be absorbed by the springs 80 of the support 40, and thus the thermal stress applied to the inner container 20 can be relieved or reduced.

The embodiments of the present invention have been described with reference to the attached drawings. However, the technical scope of the present invention is not limited by the above embodiments. The embodiments of the present invention which are illustrated in the attached drawings are applied to the cryogenic liquid storage system, but may be applied to the liquefaction system. In this case, a cryogenic refrigerator may be installed above the upper end of the inner container. This modification falls within the technical scope of the present invention.

What is claimed is:

1. A low heat loss cryogenic liquid container comprising:
an outer container, to an upper end of which an upper end cover is coupled and an interior of which is maintained in a vacuum;
an inner container that is disposed inside the outer container apart from an inner wall of the outer container and contains a cryogenic liquid;
a liquid inflow/outflow pipe that connects an exterior of the outer container and an interior of the inner container and serves as a passage for charging and/or discharging the cryogenic liquid; and
a support that is disposed between an inner lower surface of the outer container and an outer lower surface of the inner container and includes a strut member formed of a low heat conductivity material in order to interrupt heat conduction and at least one spring coupled to the strut member such that the inner container is displaceable up and down relative to the outer container.

2. The low heat loss cryogenic liquid container according to claim 1, wherein the outer lower surface of the inner container and the inner lower surface of the outer container are respectively formed with an upper bearing and a lower bearing, which include holding recesses in which upper and lower ends of the strut member are respectively held and supported, at positions opposite to each other.

3. The low heat loss cryogenic liquid container according to claim 2, wherein the holding recess of the upper bearing which is formed in the lower surface of the inner container is recessed upward from the lower surface of the inner container.

4. The low heat loss cryogenic liquid container according to claim 2, wherein the upper and lower ends of the strut member include contact seats, each of which has a cross section whose width or diameter is larger than an outer diameter of a tube positioned between the upper and lower ends of the strut member and has a shape tapered toward an end thereof.

5. The low heat loss cryogenic liquid container according to claim 4, wherein the spring is disposed inside the holding recess at at least one position of between the upper end of the strut member and the outer lower surface of the inner container and between the lower end of the strut member and the inner lower surface of the outer container.

6. The low heat loss cryogenic liquid container according to claim 5, wherein the strut member includes a hollow tube in a vacuum at the core thereof.

7. The low heat loss cryogenic liquid container according to claim 4, wherein:
the strut member includes a hollow tube in a vacuum and plug members coupled to upper and lower ends of the hollow tube;
the plug members include fitting portions fitted into opposite ends of the hollow tube and the contact seats integrally formed with the fitting portions, wherein at least one of the fitting portions of the plug members coupled to upper and lower ends of the hollow tube is coupled to be movable up and down along the hollow tube; and
the spring is disposed inside or around the hollow tube between the plug members.

8. The low heat loss cryogenic liquid container according to claim 4, wherein heat isolation blocks formed of a low heat conductivity material are installed in the holding recesses between the upper or lower end of the strut member and the outer lower surface of the inner container or the inner lower surface of the outer container.

9. The low heat loss cryogenic liquid container according to claim 8, wherein, when the heat isolation block is disposed in the holding recess in the vicinity of the outer lower surface of the inner container or the inner lower surface of the outer container, an epoxy pad supporting the heat isolation block is provided at an inner edge of the holding recess.

10. The low heat loss cryogenic liquid container according to claim I, wherein the low heat conductivity material includes a glass reinforced epoxy laminate (GREL).
